(19) United States
(12) Patent Application Publication
(10) Pub. No.: US 2006/0001961 A1
(43) Pub. Date: Jan. 5, 2006

(54) Method for producing a display screen

(76) Inventor: Daniel Gibilini, Saint Marin d'Uriage (FR)

Correspondence Address: ROTHWELL, FIGG, ERNST & MANBECK, P.C., 1425 K STREET, N.W., SUITE 800, WASHINGTON, DC, 20005, US

(21) Appl. No.: 10/504,974

(22) PCT Filed: Feb. 18, 2003
(86) PCT No.: PCT/EP03/02311

§ 371 Date: May 13, 2005

(30) Foreign Application Priority Data
Feb. 18, 2002 (FR) 02/02086
Aug. 30, 2002 (FR) 02/10829
Sep. 3, 2002 (FR) 02/10885

(51) Int. Cl. G03B 21/60

(52) U.S. Cl. 359/456

(57) ABSTRACT

To produce a display screen, one forms an opaque layer (6) on a substrate (2) having focusing elements (4); this formation begins with the deposition of an ink or suspension on the face of the substrate directed away from the focusing elements; one then irradiates the opaque layer through the focusing elements (4) to form openings (8) in the opaque layer. This irradiation may be performed by laser, in such a way as to destroy the opaque layer at the focal points of said focusing elements. One then forms a diffuser layer in said openings (8) of the opaque layer (6) or on all of the opaque layer. The use of an ink or a suspension improves the adhesion of the opaque layer as well as the contrast of the screen.

The aim of the invention is a display screen for professional and general public applications (television, multi-screen projections, graphic high resolution monitor, etc.).

This type of display screen is described in WO-A-00 67071. The reader may refer to this application for a discussion of the ideal properties of display screens and for definitions of the contrast, the transmittivity and other parameters defining display screens. A more specific definition of the contrast is also discussed below.

U.S. Pat. No. 5,870,224 describes a display screen. This display screen has an opaque layer formed by stacking and cannot provide good contrast.

There is still a need for a display screen having contrast characteristics as good as those of WO-A-00 67071, but which is even simpler to manufacture.

The invention thus proposes, in one embodiment, a method for manufacturing a display screen comprising:
the formation of an opaque layer on a substrate having focusing elements, this step including the deposition of an ink or suspension;
the formation of openings in the opaque layer with an irradiation through the focusing elements, and
the formation of a layer, at least in the openings of the opaque layer.

Advantageously, the step of forming an opaque layer comprises printing with an ink. The printing may then be performed by flexographic or screen printing. The step of forming an opaque layer may also be performed by projecting a suspension.

In one embodiment, the substrate has a roughness of at least ±2 μm and less or equal to ±5 μm.

One can also provide for forming openings in the opaque layer an irradiation of the opaque layer through said focusing elements with the aid of a laser. In this case, it is advantageous to provide a pre-focusing of the laser, with a focal length greater than or equal to 10 cm.

One can also provide for adapting the power distribution in the laser beam facilitating uniformity of exposure during adjacent passes of the beam.

For a substrate in plastic material, a YAG laser is suitable.

One can also provide for the formation of openings in the opaque layer by the following steps:
forming a negative photosensitive layer on the substrate;
irradiating the negative photosensitive layer through the focusing elements;
removing the non-irradiated photosensitive layer;
applying an ink or suspension;
removing the irradiated photosensitive layer.

In this case, it is advantageous if the photosensitive layer has a thickness greater than or equal to 10 μm, and that the ink or suspension is applied at a thickness less than half the thickness of the photosensitive layer.

The step of forming openings in the opaque layer may also comprise:
forming a negative photosensitive layer on the substrate;
irradiating the negative photosensitive layer through the focusing elements;
removing the non-irradiated photosensitive layer;
applying an ink or suspension;
removing the opaque layer on the irradiated photosensitive layer, by irradiation through the focusing elements.

In this case, removing the opaque layer on the irradiated photosensitive layer is typically carried out by laser irradiation.

One can then apply an adhesive onto the opaque layer, then apply on the adhesive a diffuser or a support.

One can also only apply a diffuser in the openings of the opaque layer. In this case, applying a diffuser may comprise:
applying a negative photosensitive diffuser onto said opaque layer having openings;
irradiating the negative photosensitive diffuser through the focusing elements, and
removing non-irradiated negative photosensitive diffuser.

The application of a diffuser is performed for example by applying the diffuser in a pasty form by means of a squeegee onto the opaque layer having openings.

One can provide for bonding a support after applying the diffuser.

Other characteristics and advantages of the invention will become clear in the description that follows of the various embodiments of the invention, which are given by way of example, and by referring to the Figures which show:

FIG. 1, a schematic cross-sectional view of a display screen produced according to a first embodiment of the method of the invention;

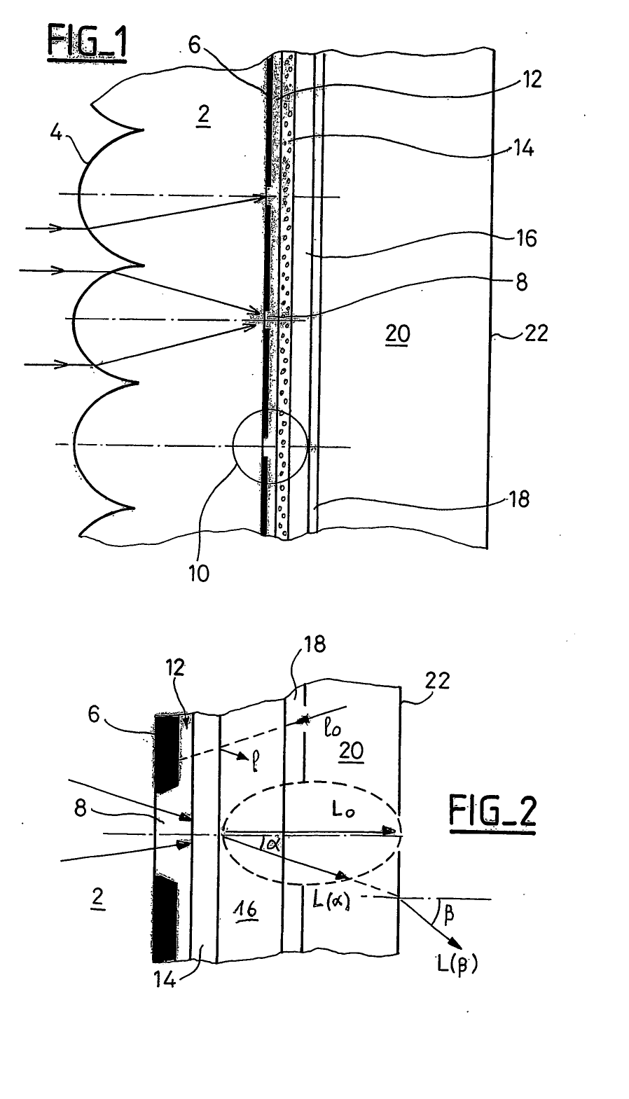

FIG. 2, a larger scale view of part of the display screen of FIG. 1;

FIG. 3 a similar view to that in FIG. 2, for a display screen produced according to a second embodiment of the method of the invention;

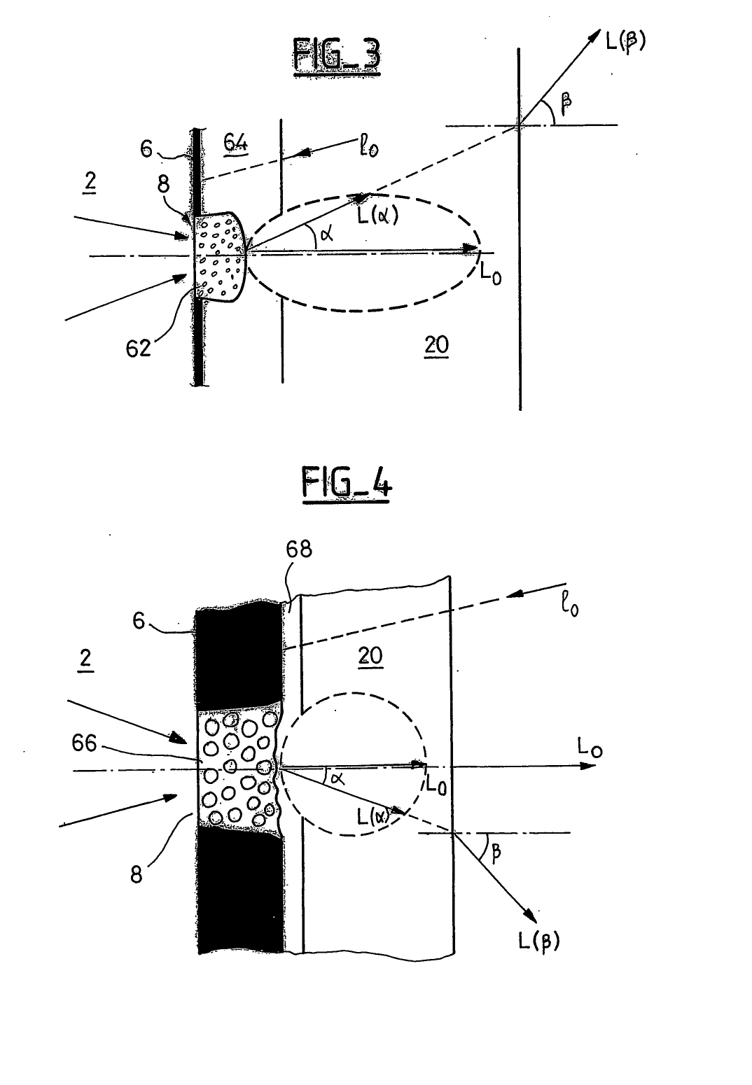

FIG. 4 a similar view to that in FIG. 2, for a display screen produced according to a third embodiment of the method of the invention;

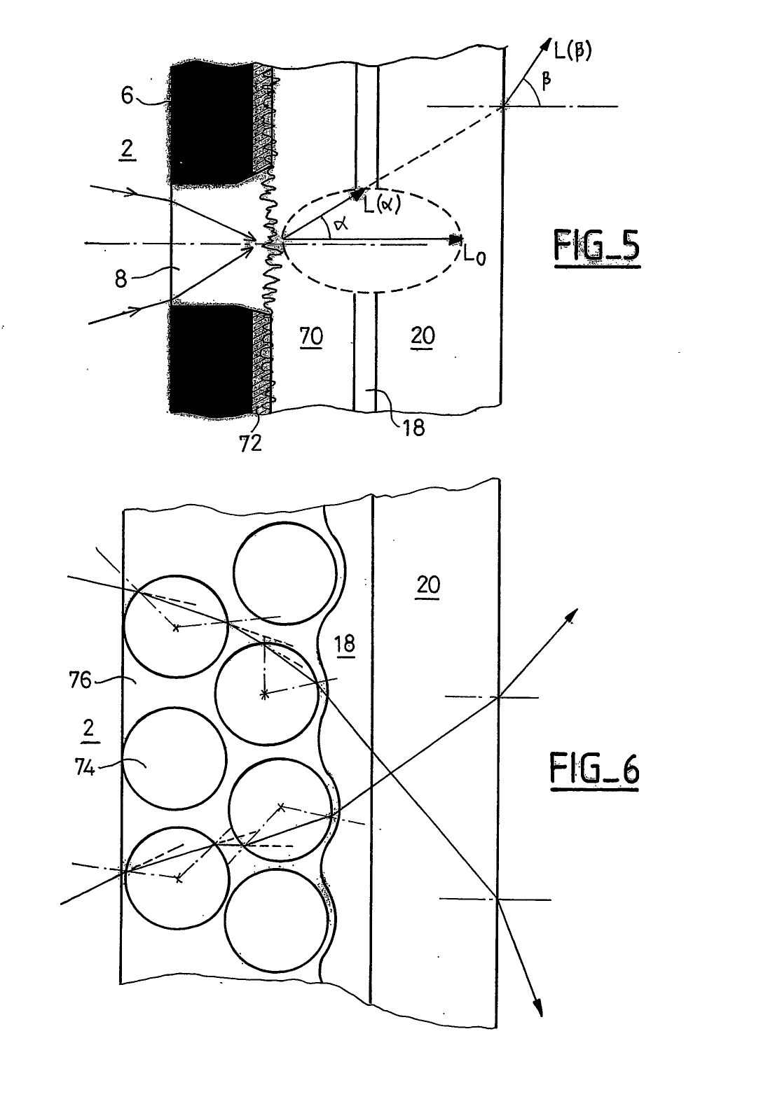

FIG. 5 a similar view to that in FIG. 2, for a display screen produced according to a fourth embodiment of the method of the invention;

FIG. 6, an even larger scale view of a micro-bead diffuser;

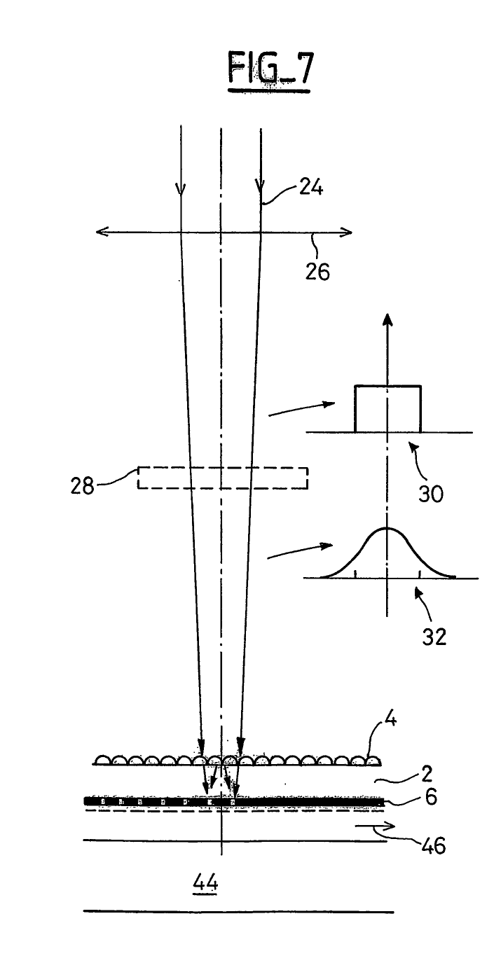

FIG. 7, a schematic view of a laser irradiation installation of the opaque layer of the display screen;

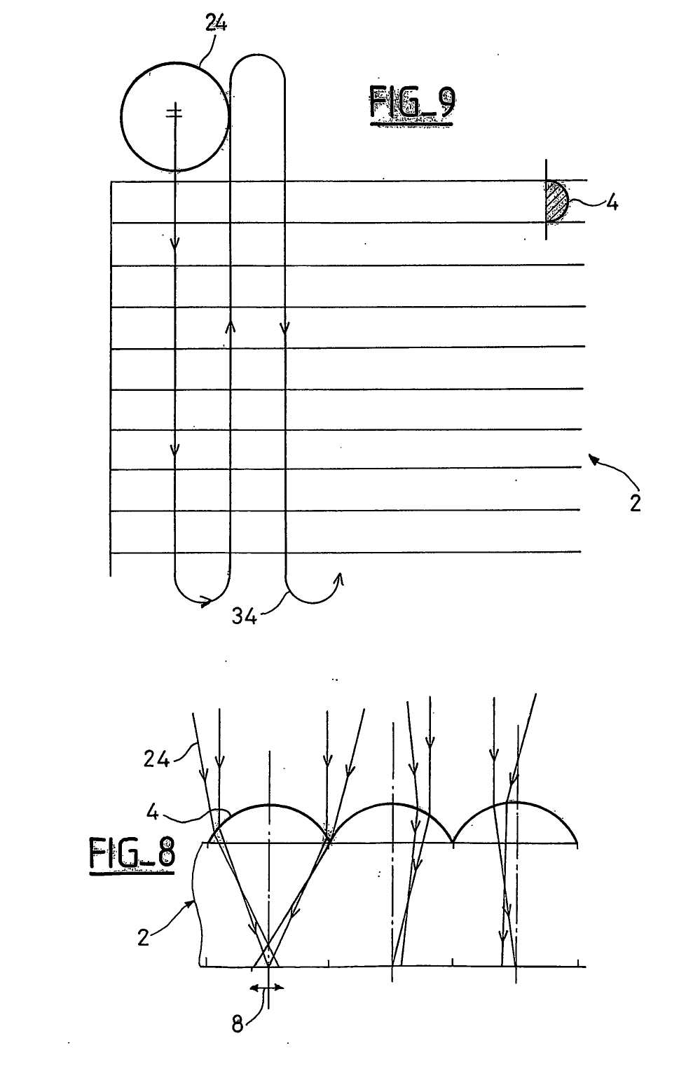

FIG. 8, a larger scale schematic view of the substrate shown in FIG. 7, with the laser beam;

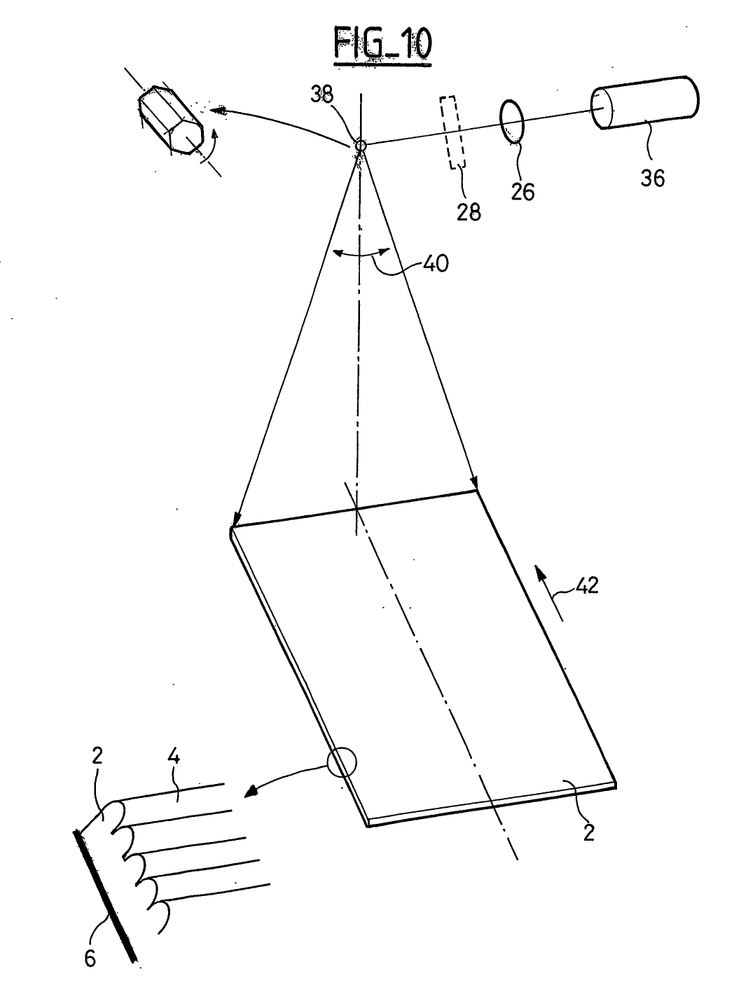

FIG. 9, a scanning pattern for a laser irradiation;

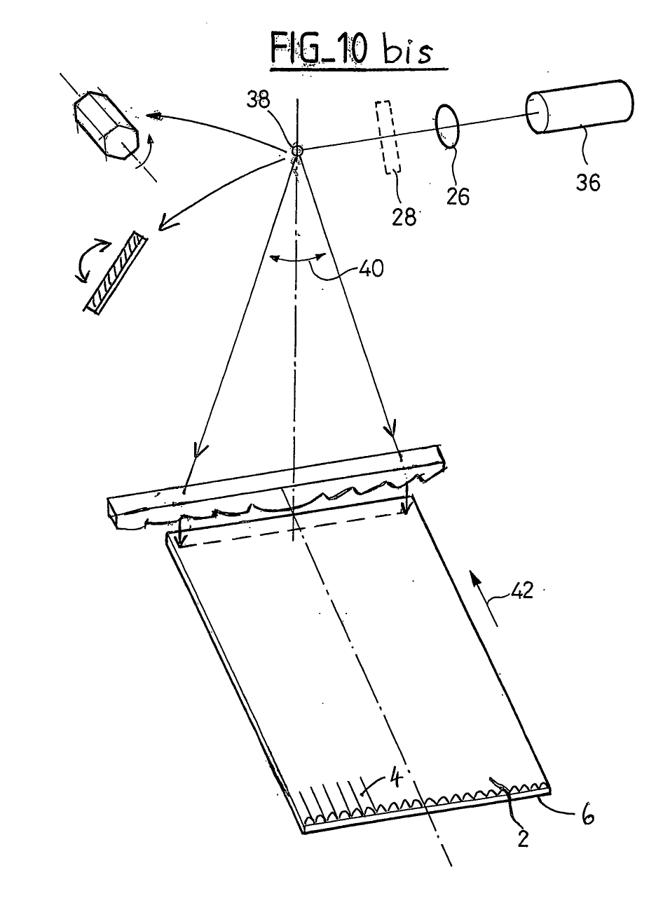

FIG. 10, a schematic representation of an irradiation installation;

FIG. 10bis, a schematic representation of another irradiation installation;

FIGS. 11 to 14, a schematic representation of the steps of forming the opaque layer with its openings.

The invention proposes a method for producing a display screen, comprising:
forming an opaque layer on a substrate having focusing elements, this step including depositing an ink or a suspension;
forming openings in said opaque layer with irradiation through said focusing elements;
forming a layer, at least in said openings of the opaque layer.

The use of an ink or a suspension for forming the opaque layer enables an opaque layer to be obtained that is very black, which has high robustness and which provided high opacity. This opacity of the layer contributes to the contrast of the display screen.

The proposed production method makes it possible to obtain firstly a high optical transmission T, typically T>0.70, under collimated illumination of the display screen; one can measure the transmission as the proportion of incident collimated light on the focusing elements of the substrate—for example at the output of the Fresnel lens of the display screen—which crosses the screen and reaches the user. In the Figures, this corresponds to a light propagation from the left to the right.

The proposed production method also makes it possible to obtain an external surface on the observer's side that appears as dark as possible under ambient light in the non-lit image zones. One obtains a high contrast C, typically C>500.

FIG. 1 shows a schematic cross-sectional view of a display screen produced according to a first embodiment of the method of the invention; this screen comprises a substrate 2 having focusing elements 4, which in the example are semi-cylindrical lenticulars of dimensions from 100 to several hundred microns. One could also use micro-lenses or micro-beads. The incident light corning from a light source is focused by the focusing elements, as shown by the lines in the Figure. The diagonal size of the screen is, for example, 100 inches (2.54 m), i.e. 2 m×1.5 m in 4/3 format.

On the surface directed away from the focusing elements is provided an opaque layer 6; the opaque layer extends along the focal plane of the focusing elements; the surface directed away from the substrate advantageously has a certain roughness, as explained hereafter. The opaque layer is responsible for the absorption of the ambient light and has a thickness that can vary from one to several tens of microns (for example 20, 30or 40 microns). The opaque layer has openings 8 at the focal points for letting through useful light projected from the rear of the screen towards the user. The openings have a surface area less than 10% or even 5% of the total surface area of the display screen. Reference 10 in FIG. 1 shows an opening in the opaque layer; FIG. 2 shows a larger scale view of this opening.

A diffuser 14, 16 is bonded onto the opaque layer 6 with the help of a layer of adhesive 12. The diffuser 14, 16 is active at the focal points—at the level of said openings in the opaque layer. The diffuser is formed from an active layer 14 and a support 16, as explained hereafter. The angle of light emission determines the luminance of the screen as a function of the alpha angle compared to the normal at the screen, as explained in reference to FIG. 2. FIG. 1 also shows a second layer of adhesive 18 enabling a support 20 to be fixed onto the active diffuser 14, 16. The support 20 acts as a general support for the screen. It is typically several millimetres thick and may be coated on its external face 22, directed towards the user, with an anti-reflective layer, either a Moth-eye antireflective microstructure or a thin film coating.

FIG. 2 shows a larger scale view of the display screen, at the level of an opening through the opaque layer; the Figure is schematic, in that it also shows the surface 22 of the support 20, in such a way as to illustrate the path of the rays.

FIG. 2 shows the diffuser 14, 16. One can use a commercially available diffuser, as explained hereafter, with an active layer 14 arranged on a support 16.

The diffuser has a light emission lobe that enables the light emitted by the display screen to be adjusted. For example, a large emissivity on the horizontal axis combined with a closed angle on the vertical is obtained by using a holographic diffuser, with an emission angle on the horizontal of 95° and an emission angle on the vertical of 35°. These values are suitable for an everyday rear projection application, but it is more generally understood that the emission characteristics of the diffuser may be adapted as a function of the desired application of the display screen.

FIG. 2 shows the emission of light L₀ by the screen; it also shows a ray exiting the active layer 14 of the diffuser with an angle α and with an intensity L (α); the ray is refracted when it goes through the external surface 22 of the support 20 and comes out of the screen at an angle β. It is understood that the presence, should this be the case, of the support 20 has an effect on the emission lobe of the screen. One can thus take the optical characteristics of the support into account in order to adjust, should this be necessary, the emission characteristics of the diffuser, as a function of the desired emission lobe at the screen output. FIG. 2 shows the case of an adhesive 8, 18, a diffuser support 16 and a support 20 with suitable refractive indices. More precisely, the adhesive 12 assures the optical coupling between the substrate 2 and the diffuser 14, 16; in the same way, the layer of adhesive 18 assures the optical coupling between the diffuser 14, 16 and the screen support 20.

FIG. 2 also shows the incident light l₀ on the screen, on the user's side. A proportion 1 of this light is backscattered towards the user.

The nominal contrast of a display screen is defined, in a known manner, by the ratio L₀/(l₀×R) between the light Lo emitted by the screen and the result of the incident light l₀ on the screen multiplied by the reflection R of the screen. This definition may also be expressed as C=L₀/1, with the notations of FIG. 2.

More precisely the contrast is related to the luminous flux F of the projector in lumen, the ambient lighting E in lux, the transmission T in % of the screen, the diffuse reflectance in % of the screen, the gain G of the screen related to a lambertien screen, the surface S of the screen.
C=F/E×T/R×G/S

With R=R1+R2

R1=1% is the reflectance of the Moth-eye antireflective layer.

For FIGS. 3 to 5 : R2=Rd×X %; Rd is the reflectance of the diffuser around 15% for a conventional one; X % is the aperture ratio of the openings 8 in the black layer 6; with X=10% R=1%+1.5%=2.5%

With F=500 lumens, E=100 lux, T=70%, R=2.5%, G=2.5, S=1 m²: C=350

For a surface active diffuser, Rd could be as low as 1% leading to R=1%+0.1%=1.1% and C>700.

For the FIG. 1: R2=Rd/2×(1×X %)+Rd×X % because the diffluser glued to the black layer reflects around half of the light than when working alone ; R2=7.5%+1.5%=9% leading to R=10% and C=90; to increase the contrast in the case of FIG. 1, one should increase the gain of the screen with consequently a lower viewing angle or increase the power of the projector; for example G=5 and F=100 lumens increase C from 90 to 360.

We will now detail the different parts of the screen in FIGS. 1 and 2. The support 2 has focusing elements. One can use, as in the example in the Figure, semi-cylindrical lenticular elements with dimensions from 100 to several hundred microns; typically 400 μm or 150 μm as exemplified. One could also use micro-lenses or micro-beads, with the same kind of typical dimensions. The support may simply be obtained by moulding of a plastic material such as PET, PETG or others. One can also use a substance made out of moulded glass. Although semi-cylindrical lenses are proposed here as an example, one may also use aspheric lenses.

It is advantageous in certain embodiments for the surface of the substrate on which is deposited the opaque layer 6—the surface directed away from the focusing elements in the example in FIG. 1—to have a surface roughness. This has the first advantage of favouring the adhesion of the opaque layer on the substrate. Another advantage of surface roughness is to improve the absorption of incident light 10 on the screen. As a matter of fact, the opaque layer can let through a small proportion of the incident light and the roughness reduces the light reflected towards the user. The roughness measurements used in the following description indicate the maximum value between the peaks and troughs of the surface profile, in comparison to the centre line. An indication ±2 μm thus corresponds to distances of 2 μm on either side of the centre line, i.e. a roughness Rt of 4 μm. One may also use a roughness of ±1 μm which may be sufficient for the purposes of promoting adherence between the layers. The rugosity may be shaped parallel to the lenses, e.g. in the case of semi-cylindrical lenses, so as to improve the viewing angle in a direction perpendicular to the lenses. This can be obtained by striae or marks parallel to the lenses.

The opaque layer may be obtained by using inks or suspension that are known in the market in other applications. One can use screen printing inks or sprayable suspensions. One can use gloss or matt inks or suspensions, either water- or solvent-based. The black layer may be produced by screen printing in the case of thin layers of around one micron (μm) to thick layers (several tens of μm). One can also use projection techniques and flexographic printing in the case of thin layers, which have a thickness from 1 μm to several μm.

As indicated here above, it is advantageous for the opaque layer to be applied on a rough substrate. For a thin layer of 1 μm, one could typically use a roughness of ±2 μm. For a thin layer of 3 μm, one could use a roughness of ±2 μm or ±3 μm. For a layer 20 μm thick, one could use a roughness of ±5 μm; in this latter example, the effect of reducing the reflection is less marked and the advantage of the roughness is mainly to promote the adhesion of the opaque layer. These roughnesses are greater than those normally obtained from de-moulding in the case of substrates in plastic material—which are specular. They may be obtained by surface treatment in the mould, or even by surface treatment of the substrate before the application of the opaque layer.

As discussed above, the effect of rugosity, especially for striae, may be to improve the viewing angle in a given direction.

The nature of the opaque layer and its application enable an adaptation of its thickness—typically from one μm to several tens of μm—as a function of the choice of light diffuser while at the same time maintaining the rigidity of the layer and the screen contrast. Compared to solutions involving the use of films—photographic, laminated or others—the use of printed or projected inks or suspensions enables an excellent adhesion of the opaque layer on the substrate and a good cohesion of the screen. The use of printed or projected inks or suspensions also makes it possible to obtain a blacker opaque layer than the layers of the prior art; the contrast is higher and the user does not have the feeling that the screen is grey outside of the zones where the projected image appears.

Forming layers in said opaque layer may advantageously be achieved by irradiation through the focusing elements. The objective is to obtain an opening surface area less than 10% or even 5% of the total surface area of the screen in order to optimise the contrast correlated to 90% or even 95% of the black surface of said screen. One can use laser irradiation, with sufficient power to destroy the opaque layer and form the openings 8. One can also use techniques such as the “lift-off” technique, with a negative photosensitive resin. Engraving by laser is particularly suitable for the whole range of thickness of the black layer, from 1 μm to several tens of μm. Engraving by the “lift-off” technique is particularly suitable for thin opaque layers—from 1 μm to several μm.

FIGS. 7 and 8 explain the laser engraving methods. One uses, for example, a YAG laser at a wavelength of 1060 nm in the case of a substrate 2 in plastic material (PETG or others). One can use other lasers in the case of other materials that have to be passed through, for example glass. A laser with an average power rating of 20 W can be sufficient for ablating the opaque layer and forming the openings.

One can use continuously excited Q-switched laser with average power up to 150 W; the high laser radiation is split into many low-energy pulses at high frequency up to 200 KHz. The ablation of the black layer is made “one line at a time” with high scanning frequency; thus the thermal energy delivered by the laser radiation to the ablation leads to the ablation of a controlable aperture without damaging the surrounding black layer and the substrate.

FIG. 7 shows a schematic representation of a laser irradiation installation. We have shown on the Figure the substrate 2, with the focusing elements 4 and the opaque layer formed on the side directed away from the focusing elements. The incident laser beam 24 passes through an optic 26 that ensures a pre-focusing at long focal lengths—several tens of centimetres—of the laser beam. Typically, the optic has a focal length of between 10 cm and 80 cm, preferably close to 50 cm. It is located not far from the screen; typically the distance between the focusing elements of the screen and the pre-focusing optic is around 25 cm.

This pre-focusing makes it possible to control the angle of incidence of the laser rays on the focusing elements in order to control the size of the openings. The greater the pre-focusing, the higher the angle of incidence of the laser rays and the greater the size of the openings formed. FIG. 8 is a larger scale view that schematically shows the effect of the pre-focusing, the incident rays with an angle compared to the average direction of the laser beam leading to the widening of the openings.

The other parameter that makes it possible to act on the size of the openings is the power of the laser. The power required for the irradiation depends on the thickness of the opaque layer and the number of laser passes. As indicated here above, a laser with a power rating of 20 W is suitable.

After having passed through the pre-focusing optic 26, the rays from the laser pass through a micro-optic 28 that shapes the structure of the laser beam; in the example, the micro-optic 28 makes it possible to go from a power distribution of the type represented as 30 in the Figure to that represented as 32 in the Figure. The power distribution 30 before the micro-optic has a step shape. The power distribution 32 after the micro-optic has a structure that is close to Gaussian. This power distribution facilitates obtaining a uniform power density at short distance (<1 mm) during the scanning of the surface of the screen by the beam.

FIG. 9 shows an example of possible scanning, similar to TV scanning lines. We have shown in the Figure the substrate 2, the focusing elements 4—lenticular elements in the example—the spot 24 of the beam and the path 34 of the beam on the screen. In the example of focusing elements, scanning perpendicular to the focusing elements makes it possible to work with a greater tolerance than is the case with parallel scanning: as a result, moiré effects are avoided. The distance between two adjacent passes depends on the nature of the micro-optic, the aim being to standardise the energy applied to the opaque layer. This type of scanning applies for all of the types of micro-focusing elements—lenticulars; micro-lenses; micro-beads. The laser beam is immobile and the engraving table moves in an orthogonal plane to the laser beam, the apparent displacement of the laser spot on the substrate performing a TV scanning.

FIG. 10 shows a schematic view of an irradiation installation, in the case of substrate 1 with lenticulars; it enables a different scanning to that shown in FIG. 9. We have shown the laser 36, the pre-focusing optic 26, the micro-optic 28 and the screen 2. A high frequency scanning parallel to the axis of the lenticulars is combined with a slow movement—several tens of mm/s to several tens of cm/s—perpendicular to the axis of the lenticulars. The movement in the direction parallel to the axis is achieved electromechanically by rotating a mirror or a prismatic mirror 38 that ensures the scanning 40. The arrow 42 represents the movement of the engraving table. In this case, the presence of the micro-optic 28 is less necessary, the overlapping of the beam and the uniformity of the exposure resulting from the high ratio between the scanning speed along the axis of the lenticular elements and the displacement speed perpendicular to the direction of the lenticular elements.

One can use the principle of the FIG. 10 to obtain the scanning of the FIG. 9 perpendicular to the lenticular lenses : is used for that a cylinder Fresnel lens on top of the substrate 2, the axis of this Fresnel lens being parallel to the arrow 42 and the lenticular lenses 4 being also parallel to the arrow 42. The mirror 38 is located at the focus line of the cylinder Fresnel lens; by this way the laser radiation is orthogonal to the substrate 2 and the “ablation line” is perpendicular to the lenticular lenses axis making possible to work with a greater tolerance than in the case with parallel scanning.

FIG. 7 also shows solutions enabling the smoke caused by the laser irradiation and the destruction of the opaque layer in the region of the openings to be evacuated. The engraving table may comprise an upper micro-porous part 44 for sucking up the hot smoke generated by the atomisation of the black layer in contact with the engraving table; this is to avoid the re-desposition of engraving material on the parts of the black layer that have already been engraved. One can also use, instead of the micro-porous part of the engraving table, an unwinding acceptor film for the atomisation materials as used in laser printers or the acceptor film for ink in ink jet printers. The arrow 46 on the Figure represents the movement of such an acceptor film.

On the FIG. 10bis is shown the ablation system with the laser source and the optical system below the ablation table; as described above a cylinder Fresnel lens leads to a laser radiation orthogonal to the substrate 2 like on the FIG. 9 and enables the “ablation line” in dashed line on 10bis to be perpendicular to the lenticular lenses 4; furthermore, as the black layer 6 is oriented towards the top of the figure, a very efficient linear suction device eliminates the evaporated residues just in the plane which comprises the laser scanned beam. On the FIG. 10bis only mover the transparent table sustaining the substrate to be ablated.

On the FIG. 10bis, one could use a two-axis galvanometer scan system at the focus point of a circular Fresnel lens; for example the power scan 70 from Scnlab AG leading to a raster size 1500 mm×150 mm. In this configuration all is fixed.

The advantage of forming openings in the opaque layer by laser engraving is due to:
the “dry” nature of the method, which does not involve the application of liquid chemicals;
the great diversity of power ratings commercially available;
the availability of basic equipment that can be adapted to the present requirement;
the uniformity of the engraving over the whole surface and the possibility of managing in real time any non-unformities, if necessary, in order to compensate for a uniformity defect in the luminosity of the projector for example;
the simple engraving of the opaque layer for the range of thicknesses in question, in particular from 1 μm to several tens of μm;
the simple recycling of an opaque layer with locally defective engraving, for example by again irradiating at a higher laser power the islands not-engraved under the nominal power.

The technique of forming openings in the opaque layer by the “lift-off” technique is described in referring to FIGS. 11 to 14. As shown in FIG. 11, a negative photosensitive layer 48—for example a commercially available resin that is sensitive to ultraviolet radiation
is formed on the substrate 2, on the face directed away from the focusing elements. The layer has a higher thickness than that of the opaque layer to be obtained. Typically, the photosensitive layer has a thickness greater than or equal to double the black layer to be obtained; a thickness of several tens of microns is suitable.

The photosensitive layer is irradiated or exposed through the focusing elements by a suitable light; the consideration made in reference to FIG. 8 as regards the pre-focusing apply with such modifications as the circumstances require. The exposure system is well known: for example, one uses a UV lamp at the source of a Fresnel lens at the output of which is placed the exposure frame, which is under vacuum, where the substrate to be exposed is positioned. We have shown in the Figure the irradiation beam 52 and the exposed zones 50.

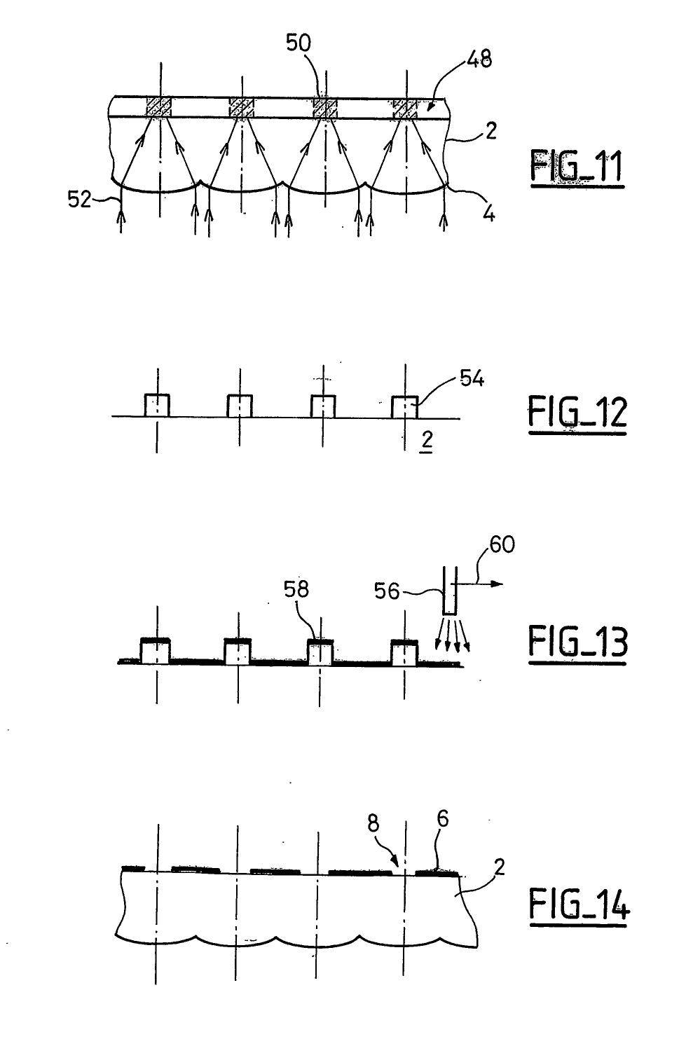

The non-irradiated photosensitive layer is removed using known techniques in order to form islands 54 of photosensitive resin, as shown in FIG. 12.

One then applies the thin opaque layer—from 1 μm to several μm. The maximum thickness of the opaque layer is a function of the thickness of the photosensitive layer, which makes this technique more suitable to thin opaque layers. FIG. 13 shows the example of an application of the opaque layer by spraying over the whole surface; one can see the spray gun 56, the opaque layer 58 and the arrow 60 representing the movement of the spray gun. Other techniques, for example printing techniques, are possible, from the moment that they allow the thickness of the opaque layer to be controlled. One can, in particular, use professional ink jet printing equipment on large flat surfaces for said spraying.

One then removes the irradiated photosensitive layer with the help of a suitable solvent that is ineffective on the opaque layer. Thus, the resin islands crowned with a thin opaque layer are eliminated. The attack on said islands is a lateral attack on the sides of the exposed parts of the photosensitive layer where the black layer is absent or discontinuous given the steep incline of the lateral surface. This mode of attack explains why the photosensitive layer is deposited at a thickness greater than the thickness of the opaque layer, as explained in referring to FIG. 11.

Forming the black layer by the “lift-off” technique makes it possible to control the size of said openings. A disadvantage is the edge/centre non-uniformity that is possible from the exposure of the negative photosensitive layer; this disadvantage may be made up for by an efficient exposure of the photosensitive layer. Like the technique for forming openings by laser irradiation, forming the opaque layer by the “lift-off” technique is performed by applying an ink or suspension; as explained above, this technique makes it possible to ensure that the opaque layer strongly adheres to the substrate. One can also provide for the substrate to have a surface roughness.

The “lift-off” technique has the advantage, compared to laser engraving, of less costly equipment.

After forming the opaque layer with its openings, the method comprises a step of forming a layer, at least in the openings of the opaque layer. This layer may be a layer of adhesive, as in the example in FIG. 1. It may also be a diffusion layer, as in the examples in FIGS. 3 to 6.

In the example in FIG. 1, the layer 18 is a layer of adhesive, applied by a printing technique, such as flexographic or screen printing. Due to the structure of the opaque layer, it is in fact possible to use a water- or solvent-based adhesive, with a good adhesion on the opaque layer and without risking destroying this opaque layer. The layer of adhesive is then covered by a diffuser 14, 16, as indicated here above.

This diffuser may be a commercially available diffuser, such as those sold by the Stewart or Da-Lite companies. It can be directly bonded onto the whole surface.

One may also use a diffuser formed from micro-beads bonded onto a support; in the example in FIG. 1, the support is referenced 16 and it is coated with an active layer 14 containing micro-beads.

The screen contrast is higher if the active face of the diffuser is bonded onto the opaque layer; in fact, in this case, the incident light is not or only slightly diffused before reaching the opaque layer and it is thus directly (but not totally) absorbed. Conversely, if the active layer 14 is directed towards the user, the incident light diffuses in passing through the support 16, of a typical thickness of 250 μm, which increases the proportion of incident light backscattered by the black layer. The screen contrast may therefore be less than that of the solutions in FIGS. 3 to 6. It is notable that the screen according to the U.S. Pat. No. 5,870,224 patent feature the limited contrast of the screen shown on the FIG. 1 due to it's stacking structure.

In the example in FIGS. 3 to 6, the layer applied onto the opaque layer with the openings ensures the diffusion, at the focal point of the focusing elements of the substrate. Outside of said focal points, the screen does not have diffuser. The ambient light is absorbed by the opaque layer. The absence of diffuser limits the reflection of ambient light and improves the contrast—in as much as the proportion of the total surface area corresponding to the openings is low. The screen in FIGS. 3 to 6 therefore is a deeper black.

In the example in FIG. 3, the diffuser forms thick islands in the openings of a thin opaque layer. We have shown in FIG. 1 the substrate 2, with the focusing elements not shown. The surface of the substrate directed away from the focusing elements is covered with the opaque layer 6 with its openings 8. One forms said islands by depositing, on the opaque layer having the openings, a diffusing photopolymerisable layer; this may be obtained by mixing diffusion elements—micro-beads or others—with a photopolymerisable resin. The diffusing photosensitive layer may have as high a thickness as desired—the only limit being the capability of irradiating this photopolymerisable layer through the focusing elements. In practice, it is possible to obtain, as in the example in FIG. 3, a diffuser with thick islands, of a thickness of several μm to several tens of μm; these islands jut out in relation to a thin opaque layer—from 1 μm to several μm; this makes it possible to obtain sufficient diffuser thickness to provide the desired diffusion. The photosensitive diffusion layer is applied by any printing technique, for example screen printing.

After application, the diffusion layer is exposed through the focusing elements 4 of the substrate 2. Due to the presence of the opaque layer, the photopolymerisable diffusion layer is only exposed at the level of said openings 8, with a profile that depends on any pre-focusing of the exposure light and the diffusion of this light in the photopolymerisable layer.

After exposure, the non-exposed part of said photopolymerisable layer is removed to obtain diffusing islands 62, located at the level of the openings in the opaque layer; as explained here above, the absence of diffuser on the opaque layer limits the reflection of ambient light, which is represented by the arrow marked l₀ in the Figure.

This process combines the very precise laser ablation of the thin black layer to a very intense UV non collimated radiation of the polymerisable diffuser through the substrate 2. This is very different from the prior art referring only to as collimated as possible UV radiation of photopolymer.

Another solution consists in combining the “lift-off” technique and the laser irradiation technique. One proceeds as described here above in referring to FIGS. 11 to 13; however, one uses a photosensitive diffuser as the photosensitive layer. After applying the opaque layer (FIG. 13), one carries out a laser irradiation, through the focusing elements; this irradiation has the effect of destroying the opaque layer deposited on the islands 54, without affecting the opaque layer deposited on the substrate 2. The diffusion of the laser light in the islands 54 does not have an effect on, and does not harm, the precision of the openings formed at the level of the substrate. One therefore has complete freedom to adapt the power of the laser without this damaging the opaque layer formed on the substrate; one has less constraints on the quality of the laser beam. One directly obtains the structure in FIG. 3, with an opaque layer and islands of diffuser 62 formed in the openings 8.

One can then apply a layer of adhesive 64 onto the opaque layer and onto the islands 62 and bond the support 20. The layer of adhesive 64 has sufficient thickness to cover the islands 62 and to ensure the optical coupling with the support 20.

The diffusion obtained typically has no directivity effect, and is a function of the thickness of the photopolymerisable layer and the nature of the diffusion elements used.

FIG. 4 shows another embodiment of the method; in the example in FIG. 4, the diffuser is introduced into the openings 8 made in an opaque layer 6 from several μm to several tens of μm thick. The diffuser has a thickness close to that of the black layer. We have shown in FIG. 4 the substrate 2, the focusing elements of which are not shown, as well as the opaque layer 6 with its openings. One places in the openings a diffuser 66. This may simply be applied in a paste form with the diffuser being applied by a squeegee, this application leading to the openings 8 being filled, whereas the surface of the opaque layer remains bare; the equipment may be a screen printing machine used without the screen.

As in the example in FIG. 3, the absence of diffuser on the opaque layer limits the reflection of ambient light l₀ and increases the contrast. One can again apply a layer of adhesive 68 to fix the support 20 onto the opaque layer. Compared to the solution in FIG. 3, the layer of adhesive may be thinner and simply has to have sufficient thickness to ensure the fixation by bonding of the substrate 2 and the opaque layer 6 onto the support 20. One can also use any type of adhesive, due to the robustness of the opaque layer.

The example in FIG. 5 shows the combination of a holographic diffuser with an engraved black layer, several tens of micrometers thick. One begins with a substrate 2 coated with an opaque layer 6 in which openings are made. One applies an adhesive 72 onto the non-engraved surface of the opaque layer, while avoiding depositing the adhesive on the openings 8 of the opaque layer. One then bonds the diffuser 70, with its active face directed towards the opaque layer. The adhesive 72, in the part of the screen corresponding to the opaque layer, fills the roughness of the holographic diffuser of the hologram and, as a result, destroys the diffusion properties of this diffuser. In the openings 8, there is no adhesive and the holographic diffuser conserves its properties. Finally, the diffuser is thus only present at the focal points and the screen contrast is optimal. One can then provide for a layer of adhesive 18 followed by support 20, if necessary.

Various solutions are possible for forming the layer of adhesive 72. As explained here above, it is simply proposed that the layer of adhesive does not come into contact with the active surface of the hologram in the part corresponding to the openings 8 in the opaque layer.

A first solution consists in coating, onto the substrate 2, a thick layer 6 of a low melting point (<100° C.) thermoplastic resin filled with graphite and therefore opaque; then forming the openings 8 by YAG laser irradiation focused by the focusing elements; the blackened holographic diffuser is then bonded by simple hot lamination onto the layer 6.

Another method for forming said layer 6 consists in applying onto the substrate 2 a thick layer of graphite filled and therefore opaque liquid adhesive then, after drying, irradiating it with a YAG laser focused by the focusing elements, in order to form the openings 8 in the opaque layer 6. A water-based adhesive is very suitable. The diffuser 70 is then laminated onto the adhesive provided with said openings.

One can also use a principle of flexographic coating of the upper surface of the opaque layer 6. A thickness of several microns of adhesive is very suitable: the grooved coating cylinder deposits a calibrated thickness of adhesive onto the upper surface of the opaque layer 6 without depositing adhesive in the openings 8. This is more advantageous than screen printing, which would lead to uniformly depositing adhesive and filling said openings 8. Screen printing may be applied in the case of UV adhesives; after exposure through the substrate 2, the adhesive is hardened in the openings of the opaque layer and does not destroy the hologram at the focal points.

One can also use a principle of bonding the diffuser 70 by micro-spraying liquid adhesive or other adhesives. A thin layer of adhesive of around one micron or several microns thick is applied onto the opaque layer 6 by micro-spraying that scans the whole surface. This adhesive layer may be:
a simple water-based adhesive;
a thermoplastic adhesive, onto which the diffuser 70 will be hot laminated;
a UV adhesive; firstly, it is polymerised in the openings by UV irradiation focused by the focusing elements ; then, the diffuser 70 is laminated onto the opaque layer, under general UV irradiation (under all angles) through the diffuser 70 to polymerise the adhesive between the bosses of the opaque layer and the diffuser 70; since the adhesive in the openings 8 has already been polymerised, it does not destroy the active surface of the hologram;
a microencapsulated adhesive (capsules of around several microns diameter); under the lamination pressure, these capsules burst between the non-engraved parts of the opaque layer 6 and the diffuser 70, thus liberating the adhesive; at the bottom of the openings 8, the capsules are not subject to any pressure, the adhesive is not liberated and the active surface of the diffuser 70 is thus preserved; the microencapsulated adhesive may advantageously be a UV type of adhesive in order to combine pressure effects on the opaque layer 6 and UV hardening in the openings 8.

In these examples, the opaque layer has the function not only of blocking the passage of light outside of the openings, but also preventing the active surface of the hologram coming into contact with the adhesive at the focal points.

Another way to build the screen is to use the well-known Cromalin positive film which losses it's adhesiveness under UV radiation. The overall process could be a very economical one “in line” as follows:

a) blackening the substrate 2 with a film as thin as 1 micron or less by a rolling process,

b) laser ablation of the black layer 6, the laser radiation being focalized by the lenses 4,

c) lamination of the Cromalin positive film on the black layer 6,

d) intense UV irradiation of the Cromalin film through the substrate 2 without the need of collimating the UV beam due to the presence of the ablated black layer 6; the Cromalin positive remains sticky elsewhere than the apertures 8,

e) lamination of a film coated with a layer of micropowder of transparent thermoplastic resin featuring a low melting temperature (<120° C.); the thermoplastic resin particles are transferred only to the sticky part of the Cromalin film, nothing adhering to the apertures 8 due to the intense UV radiation of c); convenient thermoplastic resins are metacrylate, ethyl vinyl acetate . . .

f) lamination of the diffuser on the top surface at a temperature just higher than the melting point of the thermoplastic resin which by meting fills the roughness of the active surface diffuser; by the way the diffuser is glued to the assembly and destroyed elsewhere than at the apertures 8.

That's a new advantage over the process claimed in U.S. Pat. No. 5,870,224: this one needs a very precise UV optical system that means no intense beam to get the apertures 8; that leads to poor adhesiveness instead of no adhesiveness at the focus area of the lenses 4 making useful to remove the toner adhering here; furthermore this UV process leads to an aperture ratio around 30% due to a precision smaller than the laser ablation one.

In the example in FIG. 5, we considered a classical holographic diffuser 70 with an active surface. The diffuser may also be a holographic diffuser formed by replication of a master holographic surface, by exposure of a photopolymer in contact with the master holographic surface.

To this end, one places a photopolymer on the transparent polyester support which has a typical thickness, moreover, of 1 to less than 20 microns. The support is provided if necessary with an adhesion promoter for the photopolymer of the layer. One applies onto the non-hardened photopolymer a master holographic surface and then exposes the photopolymer through the holographic surface or through the support. One then removes the master holographic surface and one obtains a diffuser assembly comprising the support 16 and the holographic layer. This assembly may be bonded onto the substrate and the opaque layer, as explained here above. The holographic surface could also be directly duplicated on the back surface of the substrate 20.

The advantage of the embodiment in FIG. 5 is that it enables the directivity of the diffuser to be freely adapted, by an appropriate choice of diffuser parameters. The proposed bonding techniques also apply to classical diffusers. One may also use active surface diffusers such as surface relief diffusers.

Surface relief diffusers are engineered perturbations in the surface plastic that refracts the projected light into a diffuse pattern. If one considers a thin cylinder light beam striking the diffuser active surface , the beam is spread into an angular lobe outlined by different directions; on the contrary, a bead or a lenticular lens refracts the cylinder beam as one in the same direction. So a beads monolayer or a lenticular array is another type of surface diffuser.

FIG. 6 shows yet another example of diffuser. It illustrates the operation of a micro-bead diffuser. This type of diffuser may be used in the example in FIG. 1—the active layer comprising micro-beads. This type of diffuser may also be used in the example in FIG. 4.

The micro-beads 74 are transparent and have a refractive index n₁. They are incorporated into a binder 76—a transparent resin—with a refractive index n₂ close to and different to the refractive index no: the absolute value |n₁−n₂| is close to 0.2; as explained hereafter, preferably less than 0.25. This value may be adapted to change the emissivity of the diffuser. Moreover, the refractive index n₂ of the binder is close to the refractive index n₀, the refractive index of the substrate 2, with typically:
0≦|n₀−n₂|≦0.2
i.e. a difference between the refractive index of the binder and the refractive index of the support less than or equal in absolute value to 0.2. This difference limits the refraction when passing from the substrate to the diffuser. If the value of the refractive index n₂ is less than the value of the refractive index n₀, one can even straighten up the light beams before reaching the micro-beads.

The diameter of the micro-beads 74 is here from several μm to several tens of μm; the apparent number of layers of micro-beads is greater than or equal to 2 in order to avoid hot points on the screen that are inherent in a single layer, the light passing directly between the micro-beads. For this value of 2 or above, the number of layers is adapted to the angle of emissivity of the targeted screen: as a result, the emissivity angle is linked to the number of refractions at the interfaces n₂/n₁—when the light penetrates into a micro-bead—and n₁/n₂—when the light penetrates into the binder. One understands the constraint on the index difference between the micro-beads and the binder: too low a value of the absolute value of the index difference makes the diffusion capacity disappear, by limiting the refraction when the light passes from the binder to a micro-bead or vice-versa. A too high value limits the transmission of the light due to a high refraction and a possibility of backscattering towards the source.

A whole range of micro-beads in plastic or glass of calibrated diameter and suitable refractive index are commercially available.

By way of example, one may consider a substrate with refractive index nₒ=1.4. In this case, one can for example choose a binder with refractive index n₂ where
1.2≦n₂≦1.6
and micro-beads with refractive index n₁ where
1.4≦n₁≦1.8
the case n₁=1 not being considered here (air bubbles).

A binder with refractive index n₂≦1.4 may be produced by a colloidal silica suspension whose refractive index is intermediate between that of silica and air.

One may then choose numerous refractive index pairs n₁ and n₂, that meet the constraints mentioned above, for example:
n₂=1.4 and n₁=1.6;
n₂=1.6 and n₁=1.4;
n₂=1.6 and n₁=1.8;
n₂=1.2 and n₁=1.4;

The different choices of refractive index values, like the number of layers, enable the emissivity of the diffuser to be controlled.

We will now give examples of screens, according to some of the examples proposed here above. The substrate 2 is a substrate in PETG plastic with a thickness of 0.7 mm provided with a network of semi-cylindrical lenticular focusing elements 4 with dimensions of 400 μm and a focal length of 0.7 mm. The focal plane is thus substantially on the face of the substrate directed away from the focusing elements. The substrate has a standard TV market size, i.e. 40 inches (101.60 cm) to 70 inches (177.8 cm) diagonally. For the professional market, one could go up to 100 inches, i.e. 2.54 m diagonally. These dimensions are in nowise limiting but purely indicative.

In the example, the screen is provided with a light diffuser localised on the focusing lines of the lenticular elements 4 of the substrate 2, according to the example in FIG. 4. The opaque layer is produced by screen printing a commercially available black ink. The following parameters are adapted in order to obtain a thickness close to 20 μm:
the viscosity of the ink, by adding a thinner if necessary, in order to obtain a viscosity of 5000 cps;
the mesh size of the screen printing screen, 40 frames/cm;
the tension of the rubber squeegee, 70 shore. After screen printing, the opaque layer is dried by passing the substrate 2, coated with the opaque layer, through a linear oven at a temperature of 50° C. The layer is then reheated in an oven at 50° C. for 2 hours.

Before the next laser engraving step, one can leave the opaque layer to stand from 0 to 3 days to optimise the cohesion of the layer and its adhesion on the substrate.

For the laser engraving, commercially available equipment adapted to the type of screen is used:
YAG laser, with a wavelength of 1060 nm and a 20 W power rating;
pre-focusing the beam by an optic with a long focal length (500 mm) compared to that of the substrate 2 (0.7 mm);
shaping of the structure of the beam by a micro-optic system that makes it possible to obtain a Gaussian power distribution;
installation of a device for drawing off the engraving smoke on the equipment table;
high frequency scanning of the laser beam parallel to the lenticulars and displacement of the engraving table at a speed of around 50 mm/s;
adjustment of the position of the engraving table in relation to the pre-focusing optic of the laser beam.

This results in the engraving of the opaque layer with the openings having a surface area less than 20% of the total surface area of the screen; which, in the present case of lenticulars of 400 μm, amounts to a network of linear windows open by 30 μm, the centre lines of which are 150 μm apart.

The light diffuser is then formed as proposed in FIG. 4 by simple application with a squeegee of a commercially available diffuser supplied in paste form. The equipment used is a screen printing machine equipped with a rubber squeegee but without the screen. The squeegee application of the diffuser fills up the 20 μm deep and 40 μm wide cavities of the engraved opaque layer.

One can also use a diffuser with perfectly spherical micro-beads, with a calibrated diameter of 6 μm and a refractive index of 1.6; a suspension of these micro-beads is produced in a UV sensitive resin with a refractive index of 1.4. The suspension is applied by squeegee onto the black layer then exposed to UV through the substrate 2 on a classical tube exposure table, a collimated UV beam not being required; the traces of suspension not exposed and therefore liquid on the black layer are finally removed by cleaning.

Finally, the substrate 2 provided with the engraved opaque layer 6 and the light diffuser localised in the cavities is bonded onto the general screen support 20, which has a thickness of 4 to 5 mm. The flexibility of the substrate 2 is used to achieve this. The surface of the opaque layer on the one hand and the rear surface of the support 20 on the other hand are pre-coated with a classical water- or solvent-based transparent adhesive that is compatible with the materials. One edge of the substrate 2 is placed in contact with the support 20, which forms a “corner” where the adhesive is added in excess; the support 20 and the substrate 2 are laminated on a cylinder laminator, the support 20 acts as a bonding base; the substrate 2 is progressively pulled down onto the support 20 with the adhesive spreading out between the two. The use of UV adhesive makes it possible to recycle it in the event where air bubbles are present, despite the excess adhesive and the lamination. One can use a transparent adhesive film laminated on the rigid substrate 20 and then laminate the flexible substrate 2 on the substrate 20 provided with the adhesive film.

After checking the appearance, the display screen is cut to the final precise size by CO₂ laser.

All embodiments of the display screen of the invention may be used with a Fresnel lens for collimating light received from the projector. In this case, light entering the display through the focusing elements is substantially collimated by the Fresnel lens.

Obviously, the invention is in nowise limited to the examples of embodiments described in referring to the Figures. Thus, in the most frequent case of a substrate 2 in plastic, one can provide for a protection of the external surface, before depositing the black layer, against possible attack from:
solvents present in the black ink
hot smoke produced by the atomisation of the black layer under laser engraving that can re-deposit despite being subject to suction; This protection may be a layer of silica SiO₂ or silicon nitride Si₃N₄ with a thickness of 300 angstroms (30 nm), formed by plasma. This protective layer does not substantially change the roughness of the external surface of the substrate and what has been said here above regarding the roughness still applies.

One could also deposit this type of protective layer on the opaque layer, if this would be useful to protect it against subsequent treatments or the materials used.

The different examples show various emission patterns; as a function of the diffuser, one can in fact choose, in all of the embodiments, the desired appearance for the emission pattern of the display screen.

1. A method for producing a display screen, comprising:
forming an opaque layer (6) on a substrate (2) having focusing elements (4), this step including depositing an ink or a suspension;
forming openings (8) in said opaque layer with radiation through said focusing elements (4);
forming a layer, at least in said openings (8) of the opaque layer (6).

2. The method according to claim 1, in which the step of forming an opaque layer (6) comprises printing with an ink.

3. The method of claim 2, in which printing is performed by flexographic or screen printing.

4. The method according to claim 1, in which the step of forming an opaque layer (6) is performed by projecting a suspension.

5. The method according to claim 1, in which said substrate (2) has a roughness of at least ±2 μm.

6. The method according to claim 1, in which the substrate has a roughness less than ±5 μm.

7. The method according to claim 1, in which the step of forming openings (8) in the opaque layer (6) comprises irradiating the opaque layer through said focusing elements (4) with the aid of a laser (36).

8. The method according to claim 7, in which irradiation comprises pre-focusing (26) the laser (36).

9. The method according to claim 8, in which the pre-focusing (26) is performed with a focal length greater than or equal to 10 centimetres.

10. The method according to claim 8, in which the irradiation comprises adapting (28) the power distribution within the laser beam facilitating uniformity of exposure during adjacent passes of the beam.

11. The method of claim 8, in which the substrate (2) is in plastic material and the laser (36) is a YAG laser

12. The method according to claim 1, in which the step of forming openings in the opaque layer comprises
forming a negative photosensitive layer (48) on a substrate;
irradiating the negative photosensitive layer through the focusing elements (4);—removing the non-irradiated photosensitive layer;
applying an ink or suspension (58);
removing the irradiated photosensitive layer (50).

13. The method according to claim 12, in which the photosensitive layer has a thickness greater than or equal to 10 μm.

14. The method according to claim 12, in which the ink or suspension is applied at a thickness less than half the thickness of said photosensitive layer.

15. The method according to claim 1, in which the step of forming openings in the opaque layer comprises:
forming a diffusing negative photosensitive layer on a substrate;
irradiating the negative photosensitive layer through the focusing elements (4);
removing the non-irradiated photosensitive layer;
applying the ink or suspension;
removing the opaque layer on the irradiated photosensitive layer, by irradiation through the focusing elements.

16. The method according to claim 15, in which removal of the opaque layer on the irradiated photosensitive layer is performed by laser irradiation.

17. The method according to claim 1, in which the said step of forming a layer comprises applying an adhesive (12, 72, 64, 68) onto the opaque layer (6).

18. The method according to claim 17, in which the method comprises applying a diffuser (14, 16, 70) onto said adhesive (12, 72).

19. The method according to claim 17, in which the method comprises applying a support (20) to the adhesive (64, 68).

20. The method according to claim 1, in which the step of forming a layer comprises applying a diffuser (62, 66) in the openings (8) of the opaque layer (6).

21. The method according to claim 20, in which the step of applying a diffuser comprises:
applying a negative photosensitive diffuser onto said opaque layer (6) having openings (8);
irradiating the negative photosensitive diffuser through the focusing elements (4); and
removing non-irradiated negative photosensitive diffuser.

22. The method according to claim 20, in which the step of applying a diffuser is performed by applying the diffuser in a pasty form by means of a squeegee onto the opaque 20 layer having openings.

23. The method of claim 20, in which the method comprises bonding a support after applying the diffuser.

24. The method according to claim 1, wherein the step of forming openings in the opaque layer comprises laser irradiating an opaque layer and wherein the step of forming a layer comprises applying a diffuser (62, 66) in the openings (8) of the opaque layer (6) and irradiating said diffuser.

25. The method according to claim 24, wherein the opaque layer has a thickness of less than 5 pm, preferably around 1 gm.

26. The method according to claim 24, wherein the step of irradiating said diffuser comprises irradiating with a non-collimated UV light.

27. The method according to claim 1, further comprising the steps of
providing a rigid substrate (20),
laminating an adhesive film on the rigid substrate and
laminating the substrate (2) on the rigid substrate provided with the adhesive film.
